(19) United States
(12) Patent Application Publication
(10) Pub. No.: US 2006/0054558 A1
(43) Pub. Date: Mar. 16, 2006

(54) Mobile phase treatment for chromatography

(76) Inventors: Brian Jones, South Jordan, UT (US); Nathan L Porter, Kaysville, UT (US)

Correspondence Address: KENNETH E. HORTON;KIRTON & MCCONKLE, 60 EAST SOUTH TEMPLE, SUITE 1800, SALTLAKE CITY, UT, 84111, US

(21) Appl. No.: 10/505,289

(22) PCT Filed: Feb. 20, 2003
(86) PCT No.: PCT/US03/05127

§ 371 Date: Jul. 14, 2005

Related U.S. Application Data
(60) Provisional application No. 60/358,926, filed on Feb. 22, 2002.

(51) Int. Cl. B01D 15/08

(52) U.S. Cl. 210/656; 210/198.2; 210/742; 210/149; 210/774; 210/175; 73/61.55

(57) ABSTRACT

A convenient and efficient method for heating or cooling the mobile phase fluid of a chromatographic system prior to its entry into the chromatographic column is described. The “preheating” or “precooling” process is carried out using an apparatus containing a short length of tubing where the mobile phase is heated or cooled. The heating or cooling is performed using a heating or cooling element that is in intimate thermal contact with the exterior of the tubing. The temperature change of the mobile phase is measured downstream by a non-invasive, low-mass sensing element on the exterior of the tubing. With a low mass heating or cooling element, the device can be very responsive and allows for rapid equilibration and convenient temperature programming of the mobile phase. This configuration also requires only a short mobile phase contact time, is non-invasive, adds no dead volume, and allows for use of columns over a wide range of internal diameter, flow rates and temperatures.

### REFERENCE TO RELATED APPLICATIONS

This application claims priority from U.S. provisional patent application No. 60/358,926, the entire disclosure of which is incorporated herein by reference.

### FIELD OF THE INVENTION

The invention generally relates to mobile phases and their use in chromatography. In particular, the invention relates to mobile phases and their use in High Performance Liquid Chromatography (HPLC). More particularly, this invention relates to a process for treating-including heating and/or cooling—and monitoring the fluids that are used as mobile phases in HPLC.

### BACKGROUND OF THE INVENTION

In the field of analytical chemistry, there has recently been an increasing emphasis on using chromatography, especially HPLC. HPLC is a tool for analyzing mixtures by separating their various components. Typically, as shown in FIG. 1, an HPLC analysis is performed with an instrument containing a solvent reservoir 1, a pump 2, an injector 3, connection tubing 4, a column oven 5, a separation column 6, a UV detector 7, a data system 8, and a backpressure regulator 9. In certain instances, heating or cooling the separation column can either increase the speed of the analysis or adjust the selectivity or separation efficiency of the chromatographic analysis.

In elevated temperature liquid chromatography, the mobile phase is often heated to the temperature of the analytical column in order to avoid thermal mismatch broadening caused by temperature gradients between the mobile phase and the column wall. These temperature gradients can produce fluid channeling within the column and analyte retentive differences, compromising separation efficiency and peak shape. A mismatched temperature can also produce the same effect in separations performed under sub-ambient conditions.

In the device of FIG. 1, the injector inserts a sample of the fluid to be analyzed into the mobile phase stream prior to entering the column. It is known that the sample can be injected at an elevated temperature by heating the mobile phase prior to injection. For such heating, it has been known to use long lengths of tubing supported in an air oven upstream from the injection valve. See, for example, N. M. Djordjevic, et al., J. Microcol. Sep. 11(6) 403-413 (1999), S. M. Fields et al., J. Chromatogr. A. 913 (2001) 197-204, and R. G. Wolcott, et al., J. Chromatogr. A. 869 (2000), 211-230). It has also been known to use a separate liquid bath containing heat transfer liquid, such as silicone or water, for the same purpose. See, for example, B. Yan, et al., Anal. Chem. 72(6) 1253-1262 (2000) and H. Poppe and J. C. Kraak in J. Chromatogr. 282 (1983) 399-412). Additional methods for heating the mobile phase are described in U.S. Pat. Nos. 4,404,845 and 5,238,557, Hewlett-Packard J. 3 (April 1984) 24, D. V. McCalley J. Chromatogr. A. 902 (2000) 311-321, and S. M. McCown, et al. J. Chromatogr. 352 (1986) 483-492.

Because of the limitations that can be imposed by some injection valves (particularly at high temperatures) and the complexities of handling hot solutions, some have resorted to an alternate technique. In this technique, the bulk of the mobile phase is preheated and then combined with a separate, cooler stream. This technique lessens the burden of heating the fluid after injection, but dilutes the sample and potentially damages separation efficiency by adding dead volume when the two streams are mixed.

Another method of mobile phase preheating couples the column outlet tubing to the column inlet tubing so that heat is transferred between these two lines in a counter-current heat exchange. This apparatus has the advantage that the outlet line is simultaneously brought closer to ambient temperature for convenience in interfacing with a detector. Another advantage is that the inlet line has heat transferred into it, thereby bringing the fluid closer to the column temperature. In this method, a heating source contacts a block containing the separation column and the inlet line is fitted into a recess in this block as an aid in achieving temperature equilibration. After equilibration is reached with the outlet line, the inlet line is near or at the same temperature as the separation column. A typical device in this method has a contact length between the lines of about 13 centimeters, in addition to the length of tubing buried within the block for final thermal equilibration with the column. Unfortunately, such long lengths of tubing can contribute to resolution loss even when the tubing is small in diameter.

One method referenced above was used in combination with a sensing mechanism. The sensing mechanism was used to sense the temperature with a thermocouple probe inserted directly in the fluid path with feedback used to control a preheater that was attached to the outside of the tubing. This method introduced the temperature probe in the flow path that added significantly to the system dead volume and potentially contaminated the fluid. While dead volume is not a great concern with wide bore columns (e.g., greater than a 4.6 mm inner diameter), its effect can be more of a problem with microbore columns. Additional disadvantages exist in that the assembly used to support the temperature probe also supplies mass that must be heated to obtain a stable temperature reading. This additional mass can also contribute to delays in implementing a temperature change by requiring a significant equilibration time. The additional mass can further limit the ability of the preheater to rapidly respond in the case of temperature programming, which can be of value in some separations. See, for example, J. High Resolut. Chromatogr. 22 (1999) 490; J. High. Resolut. Chromatogr. 23 (2000) 525; J. High. Resolut. Chromatogr. 23 (2000) 653; J. Chromatogr. A. 864 (1999) 103; J. Chromatogr. A. 874 (2000) 65-71; J. Chromatogr. A. 892 (2000) 67; J. Chromatogr. A. 902 (2000) 421-426; J. Chromatogr. A. 918 (2001) 221; J. Microcol Sep. 13(5) (2001) 179-185; J. Microcol. Sep. 11, 1999 403413; J. Sep. Sci. 24 (2001) 136; J. Chromatogr. Sci. 38 (2000) 157.

Other cumbersome methods have been used to heat the mobile phase to the desired temperature, but such methods are not very effective or convenient. Thus, there is needed a convenient and efficient means of heating the mobile phase fluid of a chromatographic system in a short length of tubing that is non-invasive, adds no dead volume, and yet may be used over a wide range of internal diameter, flow rates, and temperatures.

### SUMMARY OF THE INVENTION

This invention provides a convenient and efficient method for heating or cooling the mobile phase fluid of a chromatographic system prior to its entry into the chromatographic column. The “preheating” or “precooling” process is carried out using an apparatus containing a short length of tubing where the mobile phase is heated or cooled. The heating or cooling is performed using a heating or cooling element that is in intimate thermal contact with the exterior of the tubing. The temperature change of the mobile phase is measured downstream by a non-invasive, low-mass sensing element on the exterior of the tubing. With a low mass heating or cooling element, the device can be very responsive and allows for rapid equilibration and convenient temperature programming of the mobile phase. This configuration also requires only a short contact time, is non-invasive, adds no dead volume, and allows for use of columns over a wide range of internal diameter, flow rates and temperatures.

### BRIEF DESCRIPTION OF THE DRAWINGS

FIGS. 1-3 are views of one aspect of the chromatographic apparatus and methods of making and using such apparatus according to the invention, in which:

FIG. 1 illustrates a chromatographic apparatus in one aspect of the method of the invention;

FIG. 2 illustrates an apparatus for heating the chromatographic mobile phase in one aspect of the method of the invention; and

FIG. 3 illustrates an apparatus for cooling the chromatographic mobile phase in one aspect of the method of the invention.

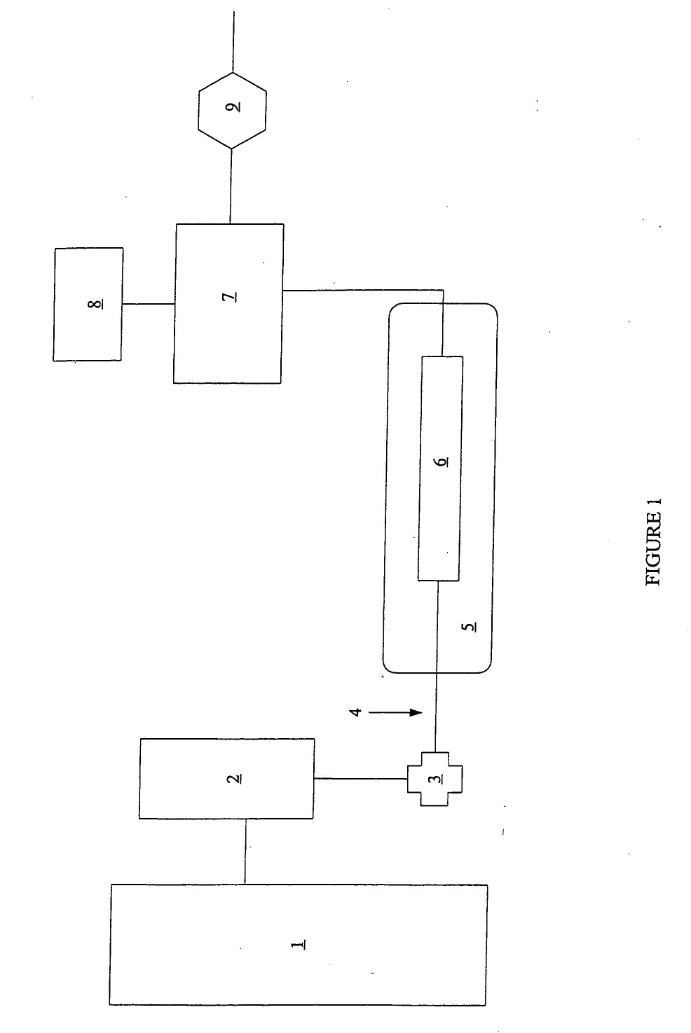

FIGS. 1-3 illustrate specific aspects of the invention and are a part of the specification. Together with the following description, the Figures demonstrate and explain the principles of the invention and are views of only particular-rather than complete-portions of the invention.

### DETAILED DESCRIPTION OF THE INVENTION

The following description provides specific details in order to provide a thorough understanding of the invention. The skilled artisan, however, would understand that the invention can be practiced without employing these specific details. Indeed, the invention can be practiced by modifying the illustrated method and apparatus and can be used in conjunction with apparatus and methods conventionally used in the industry. For example, the process and apparatus are described with respect to HPLC, but could be used in combination with other types of chromatography equipment.

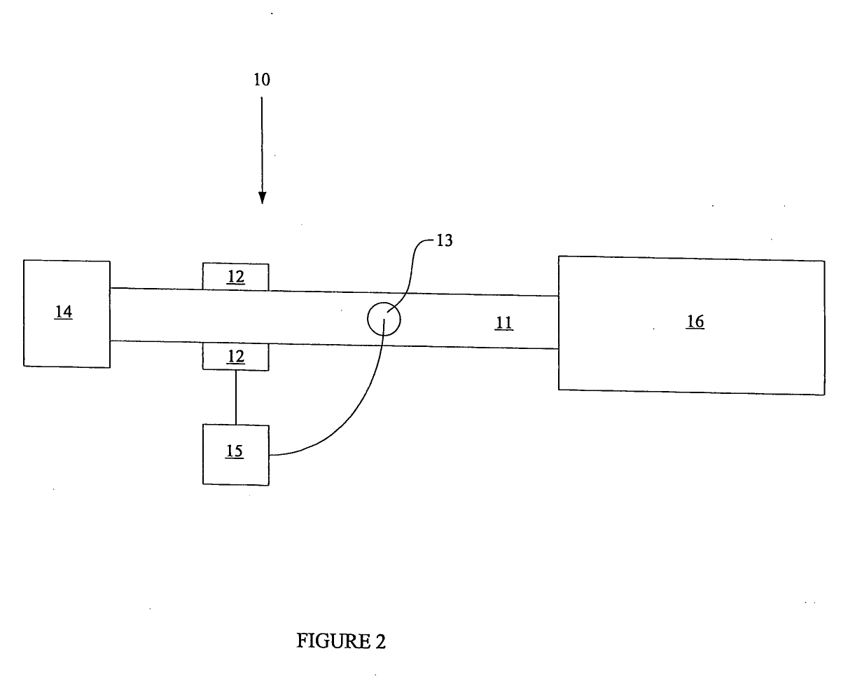

FIG. 2 illustrates one aspect of the apparatus and method of modifying the temperature of a chromatographic mobile phase fluid in the invention. Other apparatus and methods that modify the mobile phase fluid under the conditions and parameters specific herein can also be employed in the invention.

In FIG. 2, the preheating apparatus 10 is located between the injection device 14 and a chromatographic column 16. The preheating apparatus 10 comprises any suitable tubing 11 that allows the mobile phase flowing therein to be heated quickly. The tubing is connected to the injection device 14 (such as an HPLC injector) of the chromatographic column 16 using any suitable fitting (not shown), e.g., a Secure-Fit™ connector. In one aspect of the invention, narrow bore tubing is used as the tubing 11. The narrow bore tubing has any internal diameter that is compatible with the dimensions of the separation column. In one aspect of the invention, the internal diameter ranges from about 0.005 to about 0.020 inches.

The material used for such tubing can be any material that allows a rapid heat transfer, such as nickel, titanium, and stainless steel. In one aspect of the invention, the material used for tubing 11 is stainless steel. The length of tubing depends on the distance needed between the injector and the separation column. Generally, the length of the tubing can range from about 4 to about 36 inches. In one aspect of the invention, the length of the tubing can range from about 6 to about 12 inches.

The preheating apparatus also contains a heating element. The heating element can be located anywhere along tubing 11 that will allow proper heating of the mobile phase under the parameters described herein. In one aspect of the invention, the heating element is located a short distance away from the column 16, e.g., about 1 to about 3 inches.

The heating element can be any mechanism that will provide the necessary amount of heat to the mobile phase in the desired time. In one aspect of the invention, the heating element is a heater cartridge 12. A typical heater cartridge with a 50 to 70 watt range is sufficient to heat most mobile phase fluids up to or greater than about 200 degrees C. above ambient at flow rates up to about 5 ml/min. A higher wattage heater cartridge, or multiple lower wattage cartridges in series or parallel, may be used for operating at higher flow rates or at a higher heat transfer rate. A lower wattage heater cartridge can be used where a lower flow rate or a lower heat transfer rate is needed.

In one aspect of the invention, the heating element is placed on the outside of the tubing 11 so it is in intimate thermal contact with the tube. One convenient, but not limiting, method for accomplishing this contact is to use highly thermally conductive copper tubing with an appropriate internal diameter as an outer sleeve to hold the heater cartridge 12 and tubing 11 together. Optionally, a small amount of metal solder can be added to form a fillet between the heating element and tubing to increase the thermal transfer rates between them.

In another aspect of the invention, the heating element comprises a resistance wire that is wrapped around the tubing 11. The wire is connected to an electrical power source which heats the wire and then the wire transfers heat through the tubing wall into the mobile phase. Any wire that has a high resistance can be employed in the invention, such as Nichrom 60, Nichrom 80, manganin, and narrow gauge Nichrom wire. The wire can be optionally insulated with any suitable insulation, such as silicone impregnated glass insulation.

In this aspect of the invention, the wire can be wrapped around the tubing with any suitable configuration for the desired heat transfer parameters. The wire can be wrapped very close together or can be spaced by about 0.125 inches depending on the desired heat transfer. The number of windings of the wire can be about 10 to about 90. As well, the wires can be wrapped in a single layer or multiple layers, again depending on the desired heat transfer. In one aspect of the invention, such as where narrow gauge insulated Nichrom wire is used, the wire is wrapped in a single layer with a distance of 0.002 inches between successive windings and with 45 windings.

Using such heating elements as described above provides several advantages. First, they have a low mass, e.g., a mass of about 10 to about 200 milligrams. Second, since the heating element is in intimate contact with the tubing, the heat transfer is very rapid. Third, a low heat capacity combined with a small size provides an extremely fast temperature response with more accurate control and with less hysteresis in the output temperature.

A short distance downstream from the heating element, a temperature sensing element connected to a temperature control mechanism is placed on the tubing. The temperature sensing element is used to provide an electrical response as a function of the temperature. Using the detected temperature, the temperature control mechanism adjusts power to the heating element and, therefore, precisely controls the temperature of the mobile phase fluid. Power delivered to the heater element can be controlled by varying the voltage, duty cycle, or through pulse width modulation.

In one aspect of the invention, the temperature sensing element comprises a thermocouple 13. The thermocouple is usually located a short distance from the heating element. Any distance serving this function can be employed in the invention, e.g., about 0.25 inch. In one aspect of the invention, the distance to the heating element is nominally set to several times the wall thickness of the tubing.

The thermocouple 13 can be electrically insulated or soldered directly to the outside of the tubing wall. The use of an appropriate flux with the thermocouple 13 allows for wetting of the tubing surface (i.e., stainless steel) by the solder, thus insuring intimate thermal contact of the probe tip (of the thermocouple) with the outer tubing wall. Because the operating temperatures may exceed the melting point of the solder, the probe may become detached from the tubing. Thus, the probe can be secured in an auxiliary manner, such as by lashing it in place with fine wire, or by brazing with a higher temperature alloy. To minimize the influence of the environment surrounding the thermocouple probe, the tube can be insulated with high temperature insulation at the point of probe contact. This ensures that the probe reads the tubing wall temperature, which accurately follows the temperature of the fluid in the tubing.

In one aspect of the invention, the temperature control mechanism comprises a controller 15. Any suitable controller known in the art can be used as controller 15, such as an Omega Industries Series CN9000 controller, Omron Programmable Ramp Soak Process Controller, or a microprocessor. In one aspect of the invention, a PC104 style microcomputer is used as the controller.

The apparatus of the invention heats the mobile phase fluid to the desired temperature by superheating the outside wall of tubing 11 in the area of the heating element. The temperature differential between the heating element and the mobile phase fluid may range from about 5 to about 200 degrees Celsius. In one aspect of the invention, the temperature differential is several tens of degrees Celsius. This temperature differential allows for very rapid heat transfer rates from the heating element into the moving fluid. Generally, the heat transfer rate of the energy into the mobile phase fluid can range up to about several hundred watts. In one aspect of the invention, this heat transfer rate ranges from about 1 watt to about 100 watts. As one example, with a mobile phase velocity of 9 ml/min inside a 0.005″ inner diameter tube, a volume of the heated zone of 380 nanoliters, a contact time within a 3 cm heated zone of 2.5 milliseconds, with stainless steel tubing, and using a Nichrom wire, a heat transfer rate of about 100 watts was obtained and heated the mobile phase to 200 degrees C.

With the apparatus as described above, all the heat input and sensing occurs on the outside of the tubing, allowing the apparatus to be non-invasive. As well, the heating element may reach temperatures higher than the control temperature, but at no point does the mobile phase fluid within the tubing approach such a temperature. Because the heating element is controlled by using the temperature sensing element, the invention can automatically compensate for the heating requirements of fluids with a wide range of heat capacities at different flow rates.

The heating element of the invention has a low mass and can respond quickly in a controlled fashion for temperature programming. Thus, in one aspect of the invention, the preheating assembly is not thermally insulated and is contained in an air oven containing the separation column. The air moving across the assembly in the oven can quickly cool the device, allowing for quick recovery to a low starting temperature for repetitive programmed runs. Fluid temperature program rates in excess of 10 degrees Celsius per second have been obtained in this aspect of the invention.

Attaching the temperature sensing element and temperature control mechanism in close proximity to the heating element provides a safety mechanism when there is no mobile phase flow. In this situation, heat is conducted through the metal tubing wall into the temperature sensing element, producing a response in the temperature control mechanism that controls the energy input into the heater element and therefore prevents overheating.

In the configuration of the apparatus described above, the temperature of the wall of the tubing should follow that of the fluid inside. To verify this condition, a test was performed wherein a low mass temperature probe was installed within the flow path a short distance from the heater assembly using a tee. At flow rates from 0.5 ml/min to 9.999 ml/min with water as the fluid, the wall temperature sensor followed the temperature of the water in the flow path within 0.5 degree.

In other aspects of the invention, alternative methods of adding thermal energy to the mobile phase fluid through the tubing wall may be employed. These alternative methods include heat from a combustion process, inductive heating, resistive heating, passage of superheated air across the tube, radiant heat, or a combination thereof. In other aspects of the invention, alternative methods of sensing the fluid temperature as evidenced by the tubing wall temperature can be employed. Such alternative methods include the use of a thyristor or platinum RTD, or other material producing an electrical effect directly as a result of its contact. In another aspect of the invention, sensing and quantifying the infrared emissions from the outer wall of the tube could be used to provide feedback to the heating element as a means of controlling the fluid temperature.

Not only can the invention be used for heating the mobile phase fluid, but it also can be used to for cooling purposes. In certain instances, chromatographic procedures are carried out at lower temperatures and the mobile phase needs to be cooled to such temperatures. For example, in the separation of enantiomers, the temperature is often lowered below ambient to maximize resolution of the analytes.

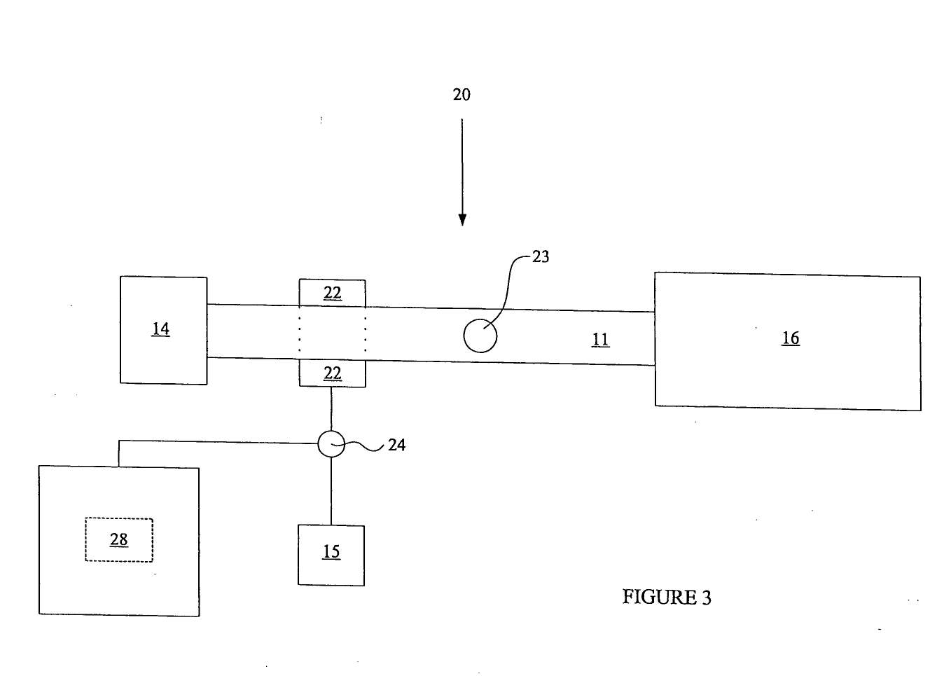

The apparatus 20 used to cool the mobile phase fluid is similar to the apparatus used to heat the mobile phase fluid, with a few modifications. As illustrated in FIG. 3, the apparatus 20 is similar with the exception that a cooling element is used in place of the heating element. In this aspect of the invention, the cooling element can be any of those known in the art, such as a thermoelectric cooler or cryo-fluid dispensing valve. For example, the cooling element can comprise a pulsated Peltier-driven solid state cooler or passive heat sink that can cool the mobile phase fluid to the desired temperature.

In one aspect of using the cooling apparatus, the temperature sensing element is an RTD 23, including flexible platinum-based RTDs. While the RTDs can also be used in the preheating apparatus in place of thermocouples, they are more expensive than thermocouples and so would be less desirable for use in the heating apparatus. Because of their ability to accurately sense low temperatures, they are more conveniently used for mobile phase precooling applications. Indeed, using a Peltier cooler and platinum RTDs is especially advantageous and can allow cooling to temperatures of about −10° C. with a variety of mobile phases and flow rates.

In another aspect of the invention, the cooling element comprises a cryogenic cooling means. In this aspect of the invention, such means comprises a cryogenic fluid reservoir 28 and means for applying the cryogenic fluid to a specified section 22 of the tubing wall. In one aspect of the invention, the means for applying the cryogenic fluid to the tubing wall is a control valve 24. The cryogenic fluid can be liquid carbon dioxide from a tank or liquid nitrogen from a refrigerated dewar.

Using the cryogenic cooling means, the temperature of the mobile phase can be drastically lowered. In one aspect of the invention, with the cryogenic fluid being liquid carbon dioxide, the temperature of the mobile phase can be lowered from about 5° C. to about −60° C. In another aspect of the invention, such as where methanol is used as the mobile phase, a temperature of −30° C. can be obtained for a flow rate of about 0.5 to about 3 ml/min.

Using the cooling apparatus, the heat transfer rate of the energy out of the mobile phase fluid can range from about 1 to about 100 watts. In one aspect of the invention, this heat transfer rate can range from about 2 to about 70 watts.

The invention is exemplified by the following non-limiting Examples.

### EXAMPLE 1

15 cm sections of 0.005″ and 0.007″ (inner diameter)× 1/16″ (outer diameter) stainless steel tubing were potted in aluminum cans. The potting mix was a Duralco High Temperature Epoxy Resin fortified with 35% by weight of aluminum powder. A recess was machined into a 1.25″ diameter aluminum rod to accept a heater cartridge, which was held in place with an insulated C-clamp. A 1.25″ diameter clamp heater of 200 watts was attached to the outside of the aluminum rod, and a temperature sensor was imbedded in a hole drilled in the bottom of the rod such that the block temperature could be monitored.

A short distance from the heater assembly, a small type J thermocouple was soldered to the outside of the stainless steel tubing extending out from the can. The flow of water through the tubing was controlled with a Knauer HPLC pump. An Alltech 300 psi backpressure regulator was coupled to the outlet of the tube to prevent boiling of the water inside the heated zone when the device was operated at high temperatures. The power to the clamp heater was regulated through an Omega CN9000A temperature controller coupled to the thermocouple that had been soldered to the outer wall of the stainless steel tube. The voltage to the heater element was further regulated by insertion of a variable transformer between it and the temperature controller.

This apparatus was then operated and it was found that the temperature of the fluid at the tubing exit was easily controlled. The divergence in temperature between the fluid and the aluminum heating block was a function of the temperature setting of the fluid output and its flow rate, shown in the table below for a flow rate of 7 ml/min.

| Block Temperature ° C. | Fluid Temperature ° C. |
|---|---|
| 112 | 100 |
| 207 | 150 |
| 267 | 200 |
| 329 | 250 |

### EXAMPLE 2

The heater portion of the apparatus in Example 1 was simplified by attaching a short heater cartridge with silver solder directly to a piece of 0.005″× 1/16″ stainless steel tubing and using it as a connector between an injector valve and separation column. A thermocouple was soldered directly to the outside wall of the stainless steel tubing 0.25 inches downstream from the heater cartridge. The power from the temperature controller to the heater was varied using pulse width modulation (from an incandescent light dimmer). Using this assembly, phenanthrene was eluted with 13840 theoretical plates and a peak width at half height of 0.89 seconds from a 10 cm ZirChrom PDB column (4.6 mm id, 3 micron particles, 300 Angstrom pore size, Zirchrom Separations) in 46 seconds using 35% acetonitrile in water at 3 mil/min and 150 degrees C. A 2.5 microliter injection loop was used along with a UV detector at 254 nm.

With all other parameters substantially the same except active pre-heating turned off, phenanthrene eluted as a severely misshapen peak with only 653 theoretical plates and a width at half height of 12.6 seconds. As previously shown in a number of examples by J. D. Thompson in Anal. Chem. 73 (2001) 3340-3347, this type of performance is typical when mobile phase preheating is inadequate.

### EXAMPLE 3

The heater portion of the apparatus in Example 1 was modified by attaching one end of a piece of glass fiber insulated 30 gauge Nichrom 80 wire that was 15 inches long to the 0.005 inch internal diameter stainless steel tube. The wire was wrapped tightly against the stainless steel tubing and secured in place with high temperature epoxy. An insulated connection was made to TFE coated copper wire, and in the same vicinity, another TFE insulated copper wire was attached to the stainless steel tubing as a ground line to complete the circuit. The stainless steel tubing was insulated with a small piece of 70 micron thick polyimide tape, and a thermocouple was placed against it and secured with Teflon heat shrink tubing. A water mobile phase was pumped through the tubing and energy was transferred into it from the resistance wire by applying a DC voltage from 0.06 to 24 volts. The water was heated in accordance with the amount of power supplied. The temperature feedback and voltage was controlled by a PC 104 style microcomputer. The wattage was dependent on the voltage applied up to 100 watts at 24 volts. This preheater was very responsive as its mass was very small. The electrically insulated thermocouple gave the expected voltaic response with no noticeable lag in sensing.

### EXAMPLE 4

The heater portion of the apparatus in Example 1 was replaced with an aluminum block (2 inches×2 inches×114 inch thick). A groove was machined into its surface to allow for placement of a 2 inch length of stainless steel tubing in intimate thermal contact. Another track was machined into the block for insertion of another length of tubing that was connected to a Honeywell cryo valve configured for liquid carbon dioxide delivery. A Kapton encapsulated miniature flexible platinum RTD element was secured to the first stainless steel tube (with thread) about 0.25 inches from the tubing exit from the block. This junction was further insulated with a polyurethane foam sleeve. The RTD sensor was interfaced to an Omron temperature controller, which in turn provided power to the cryo valve. A flow of methanol was started through the stainless steel tubing at 0.5 ml/min. The temperature setpoint was lowered to −30 degrees C. and the cryo valve allowed the flow of coolant until the methanol mobile phase was at the setpoint. It provided coolant in pulses with spacing and duration appropriate to maintain the setpoint in the fluid. The flow rate was changed to 3 ml/min and the cryo valve adjusted appropriately. A temperature sensor against the aluminum block showed a temperature approximately 20 degrees colder than the setpoint.

Having described the preferred aspects of the invention, it is understood that the invention defined by the appended claims is not to be limited by particular details set forth in the above description, as many apparent variations thereof are possible without departing from the spirit or scope thereof.

We claim:

1. A method for treating a chromatographic fluid, comprising:
providing a chromatographic fluid;
flowing the fluid through a short length of tubing to a column;
rapidly heating or cooling the fluid through the tubing;
measuring the temperature of the fluid through the wall of the tubing; and
using the measured temperature to control the rate of heating or cooling the fluid.

2. The method of claim 1, wherein the length of the tubing ranges from about 4 to about 36 inches.

3. The method of claim 2, wherein the length ranges from about 6 to about 12 inches.

4. The method of claim 1, wherein the tubing comprises a rapid heat transfer material.

5. The method of claim 1, wherein the rapid heating or cooling occurs at a rate up to about several hundred watts.

6. The method of claim 5, where the heating or cooling rate occurs at about 1 to about 100 watts

7. The method of claim 1, including measuring the temperature using a non-invasive procedure.

8. The method of claim 1, wherein the heating or cooling occurs upstream of the temperature measurement.

9. A method for treating a chromatographic fluid, comprising:
providing a chromatographic fluid;
flowing the fluid through a tube to a column, the tube having a length ranging from about 4 to about 36 inches;
heating or cooling the fluid through the tubing at a rate up to about several hundred watts;
measuring the temperature of the fluid through the wall of the tubing; and
using the measured temperature to control the rate of heating or cooling the fluid.

10. A method for treating a chromatographic fluid, comprising:
providing a short tube connected to a separation column;
providing heating or cooling means connected to a first portion of the tubing;
providing temperature-sensing means connected to a second portion of the tube closer to the separation column than the first portion;
flowing a chromatographic fluid through the tube;
modifying the temperature of the fluid using the heating or cooling means; and
sensing the temperature using the temperature sensing means.

11. The method of claim 10, further including providing temperature control means connecting the heating or cooling means and the temperature sensing means.

12. The method of claim 11, further including using the temperature control means to control the heating or cooling means.

13. The method of claim 10, wherein the length of the tubing ranges from about 4 to about 36 inches.

14. The method of claim 10, wherein the tubing is made of a rapid heat transfer material.

15. The method of claim 10, wherein the heating or cooling means modifies the temperature at a rate up to about several hundred watts.

16. The method of claim 10, wherein the temperature sensing means is non-invasive.

17. The method of claim 10, wherein the temperature modification occurs upstream of the temperature measurement.

18. An apparatus for treating a chromatographic fluid, comprising:
a short tube connected to a separation column;
low-mass heating or cooling means connected to a first portion of the tubing;
temperature-sensing means connected to a second portion of the tube closer to the separation column than the first portion; and
temperature control means connecting the heating or cooling means and the temperature sensing means.

19. The apparatus of claim 18, wherein the length of the tubing ranges from about 4 to about 36 inches.

20. The apparatus of claim 19, wherein the length of the tubing ranges from about 6 to about 12 inches.

21. The apparatus of claim 18, wherein the tubing comprises a rapid heat transfer material.

22. The apparatus of claim 18, wherein the heating means comprises a heater cartridge or heated wire adjacent the wall of the tube.

23. The apparatus of claim 18, wherein the cooling means comprises a peltier cooler or a cryogenic fluid.

24. The apparatus of claim 18, wherein the temperature-sensing means is a thermocouple or an RTD.

25. The apparatus of claim 18, wherein the heating or cooling means has a mass ranging from about 10 to about 200 mg.

26. A chromatography system comprising a device for treating a chromatographic fluid, the device comprising:
a short tube connected to a separation column;
low-mass heating or cooling means connected to a first portion of the tubing;
temperature-sensing means connected to a second portion of the tube closer to the separation column than the first portion; and
temperature control means connecting the heating or cooling means and the temperature sensing means.

27. The system of claim 26, wherein the length of the tubing ranges from about 4 to about 36 inches.

28. The system of claim 27, wherein the length of the tubing ranges from about 6 to about 12 inches.

29. The system of claim 26, wherein the tubing comprises a rapid heat transfer material.

30. The system of claim 26, wherein the heating means comprises a heater cartridge or heated wire adjacent the wall of the tube.

31. The system of claim 26, wherein the cooling means comprises a peltier cooler or a cryogenic fluid.

32. The system of claim 26, wherein the temperature-sensing means is a thermocouple or an RTD.

33. The system of claim 26, wherein the heating or cooling means has a mass ranging from about 10 to about 200 mg.
